(19) United States
(12) Patent Application Publication
(10) Pub. No.: US 2026/0330120 A1
(43) Pub. Date: Oct. 22, 2026

(54) MULTI-STAGE THREE-DIMENSIONAL NETWORK ON CHIP

(71) Applicant: OmniLink Circuits Inc., Wilmington, DE (US)

(72) Inventor: Abdelhafid Bouhraoua, Amherst, NY (US)

(73) Assignee: OmniLink Circuits Inc., Wilmington, DE (US)

(21) Appl. No.: 19/185,255

(22) Filed: Apr. 22, 2025

(51) Int. Cl. G06F 30/3953; G06F 30/392; G06F 115/02

(52) U.S. Cl. CPC G06F 30/3953; G06F 30/392; G06F 2115/02

(57) ABSTRACT

The present disclosure discloses a system and a method for implementing a network on chip. The present disclosure further discloses a multi-stage three-dimensional (3D) network on chip (NoC). The NoC includes a 3D routing structure including a plurality of two-dimensional (2D) routing structures arranged in a side-by-side arrangement. Each of the plurality of 2D routing structures includes a plurality of routers arranged in a grid pattern across a plurality of rows and a plurality of columns. The NoC further includes a 2D grid layout having a plurality of edges configured to incorporate the 3D routing structure into the plurality of edges such that one or more routers from the plurality of routers in each of the plurality of columns are merged to form a node. Each node is mapped to an edge of the plurality of edges.

### TECHNOLOGICAL FIELD

This disclosure generally relates to Network-on-Chip (NoC) architecture, and more particularly relates to high bandwidth, low latency NoCs based on multi-stage fat-tree topology.

### BACKGROUND

The increasing demand for high-performance computing in applications such as graphics processing, artificial intelligence (AI), and machine learning (ML) has driven the need for large systems-on-chips (SoCs) with hundreds of billions of transistors. Such applications require a large number of computational resources to process and analyze large amounts of data. To achieve this level of compute throughput, parallelism is generalized and used profusely. Parallelism requires fast and efficient communication between parallel computing units.

Traditional design methods involve integrating intellectual property (IP) blocks to form the desired SoC. Examples of the IP blocks include, but are not limited to, processors, memory, hardware acceleration units, and network and peripheral interfaces. Further, the IP blocks correspond to pre-designed and pre-verified blocks of logic or functionality that can be used to build the SoC. For example, different IP blocks may be combined to create a complete SoC. However, connecting these different IP blocks together poses many concerns at several levels of design and implementation stages that are not adequately addressed, thereby limiting their capabilities to meet the communication requirements of complex systems. Examples of such concerns include, but are not limited to, communication protocol compatibility, bandwidth requirements, performance, clock distribution, and overall timing closure of the chip.

In an effort to overcome the limitations associated with the traditional SoCs including IP blocks and connecting them using ad-hoc wiring or bus based global interconnects, the networks-on-chips (NoCs) paradigm has emerged. The NoCs provide a systematic solution to address issues such as compatibility, bandwidth requirements, performance, clock distribution, and overall system timing closure. NoCs may ease the clock distribution problem and make the overall chip timing closure more manageable. However, there are nevertheless several technical challenges and limitations associated with the design and implementation of NoCs; examples include but are not limited to, complex designs and implementation, latency, and standardization of NoC protocols, interfaces, and architectures.

Therefore, there is a need for optimized solutions for NoC configurations that provide high-bandwidth and low latency, among other technical effects.

### SUMMARY

Disclosed embodiments are directed to a multi-stage three-dimensional network on chip, a system, and a method for implementing a network on chip.

In one aspect of the present disclosure, a network on chip (NoC) is provided. The NoC includes a three-dimensional (3D) routing structure including a plurality of two-dimensional (2D) routing structures arranged in a side-by-side arrangement. Each of the plurality of 2D routing structures includes a plurality of routers arranged in a grid pattern across a plurality of rows and a plurality of columns. The NoC includes a 2D grid layout having a plurality of edges configured to incorporate the 3D routing structure into the plurality of edges such that one or more routers from the plurality of routers in each of the plurality of columns may be merged to form a node. Each node may be mapped to an edge of the plurality of edges.

In an embodiment, each of the plurality of 2D routing structures further includes a plurality of links. Each of the plurality of links connects at least two of the plurality of routers based on predefined topology across at least one of the plurality of rows, or the plurality of columns.

In an embodiment, the pre-defined topology may be associated with a multistage fat tree topology.

In an embodiment, each of the plurality of 2D routing structures may be identical.

In an embodiment, each of the plurality of 2D routing structures further includes a first edge and an opposing second edge. The first edge of each of the plurality of 2D routing structures may be arranged adjacent to the second edge of an adjacent 2D routing structure from the plurality of 2D routing structures to form the 3D routing structure.

In an embodiment, the 3D routing structure includes a plurality of nodes mapped to the plurality of edges of the 2D grid layout. Each edge of the plurality of edges connects two adjacent nodes of the plurality of nodes.

In an embodiment, the 3D routing structure may be mapped into the 2D grid layout to form a network-on-chip topology such that the network-on-chip topology is compatible with a plurality of electronic design automation (EDA) tools used for implementing the plurality of 2D routing structure.

In an embodiment, each of the plurality of 2D routing structures further includes a plurality of end nodes. Each of the plurality of columns terminates at a corresponding end node from the plurality of end nodes.

In another aspect, of the present disclosure a system is provided. The system may include a network on chip (NoC). The NoC further includes a three-dimensional (3D) routing structure including a plurality of two-dimensional (2D) routing structures arranged in a side-by-side arrangement. Each of the plurality of 2D routing structures includes a plurality of routers arranged in a grid pattern across a plurality of rows and a plurality of columns. The NoC includes a 2D grid layout having a plurality of edges configured to incorporate the 3D routing structure into the plurality of edges such that one or more routers from the plurality of routers in each of the plurality of columns are merged to form a node. Each node may be mapped to an edge of the plurality of edges.

In yet another aspect of the present disclosure, a computer implemented method for implementing a network on chip is provided. The computer implemented method may include forming a plurality of two-dimensional (2D) routing structures. Each of the plurality of 2D routing structures includes a plurality of routers arranged in a grid pattern across a plurality of rows and a plurality of columns. The computer implemented method includes forming a three-dimensional (3D) routing structure by arranging the plurality of 2D routing structures in a side-by-side arrangement. The computer implemented method further includes mapping the 3D routing structure into a 2D grid layout having a plurality of edges configured to incorporate the 3D routing structure into the plurality of edges such that one or more routers from the plurality of routers in each of the plurality of columns are merged to form a node. Each node may be mapped to an edge of the plurality of edges.

Further features and advantages will become more readily apparent from the following detailed description when taken in conjunction with the accompanying drawings.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates an exemplary block diagram of a system) network on chip (NoC), in accordance with an embodiment of the present disclosure;

FIG. 2A illustrates an exemplary two-dimensional (2D) mesh topology, in accordance with an embodiment of the present disclosure;

FIG. 2B illustrates an exemplary fat tree topology, in accordance with an embodiment of the present disclosure;

FIG. 3A illustrates another exemplary fat tree topology, in accordance with an embodiment of the present disclosure;

FIG. 3B illustrates an exemplary layout for the fat tree topology, in accordance with an embodiment of the present disclosure;

FIGS. 4A-4F illustrate exemplary configurations of the multi-stage 3D NoC, in accordance with various embodiments of the present disclosure; and

FIG. 5 illustrates a flowchart of an exemplary computer implemented method for implementing a network on chip, in accordance with an embodiment of the present disclosure.

These figures are not exhaustive and do not limit the present disclosure to the precise form disclosed.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

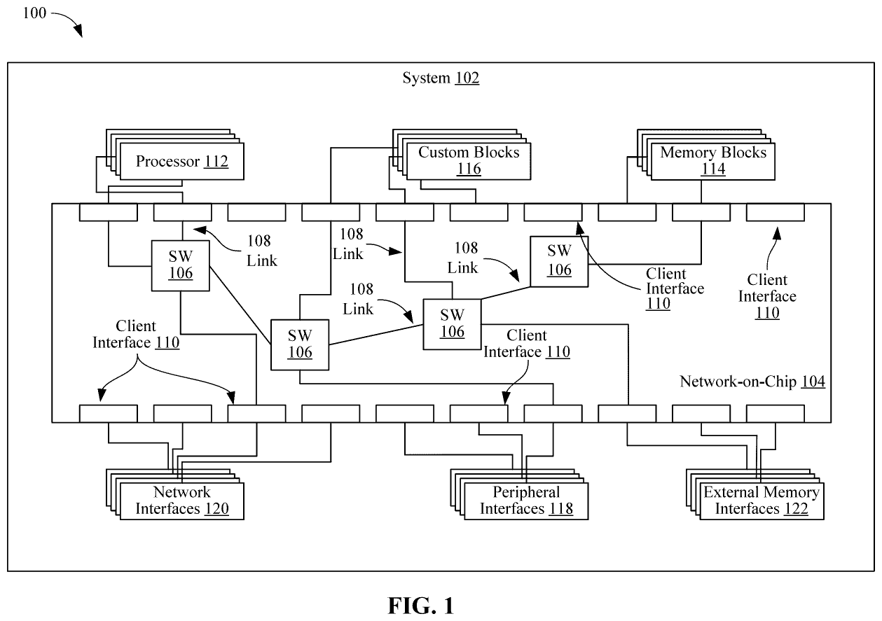

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 5, a brief description concerning the various components of the present disclosure will now be briefly discussed. Reference will be made to the figures showing various embodiments of a multi-stage three-dimensional network on chip.

Traditionally, network on chip (NoCs) are implemented using a two-dimensional (2D) structure. However, many network topologies in traditional networking are based on three-dimensional (3D) structures. In chip design and manufacturing, a true 3D structure is impractical. Therefore, creating a 3D NoC for a chip requires adapting it into a 2D layout suitable for chip design while retaining the logical 3D topology. This process is known as mapping.

FIG. 1 illustrates an exemplary block diagram 100 of a system 102 including a multi-stage 3D NoC 104, in accordance with an embodiment of the present disclosure. The NoC 104 includes a plurality of routers 106 (each labeled as SW in FIG. 1), a plurality of links 108, and a plurality of client interfaces 110. The NoC establishes connections between a plurality of processors (referred to as a processor 112, hereinafter), at least one non-transitory memory (referred to as a memory block 114, hereinafter), one or more custom function blocks 116, at least one peripheral interface block (referred to as a peripheral 118, hereinafter), at least one network interface 120 and one or more external memory interface 122. The processor 112 may be connected to the memory block 114, the custom function blocks 116, the peripheral 118, and the network interface 120 through one or more wired connections (for example, through the plurality of links 108 between the plurality of routers 106). The network-on-chip aim is to establish and realize the necessary communication between the system components that are but not limited to the processor 112, the memory block 114, the custom function blocks 116, the peripheral 118, and the network interface 120 and the external memory interface 122.

The NoC 104 may be an advanced communication infrastructure designed for system on chip (SoC) architecture. This may facilitate efficient data transfer among various intellectual property (IP) blocks such as, but not limited to, the processor 112, the memory block 114, and the peripheral 118. Further, the NOC 104 can provide a scalable and high-performance communication infrastructure that overcomes limitations in complex and heterogeneous system on chip (SoC) designs. The NoC 104 supports a wide range of applications which include, for example, but not limited to mobile devices, high-performance computing, embedded systems, and artificial intelligence (AI). Further, the NoC 104 can enhance performance, flexibility, and power efficiency of such complex systems. In an example, the NoC 104 may be used to link the nodes of a multicore, massively parallel processor architecture, thereby improving system performance. The primary function of NoC 104 is to provide a communication network with high-bandwidth and low latency. This capability is essential for most applications, particularly AI workloads. Further, the NoC 104 may support diverse applications.

The NoC 104 includes the plurality of routers 106 and the plurality of client interfaces 110 connected using the plurality of links 108 based on network topology. The plurality of routers 106 may be responsible for directing data packets from a source client interface to a destination client interface through a set of routers based on a routing algorithm. The plurality of routers 106 may correspond to switching elements of the NoC 104. Each of the plurality of routers 106 has a number of input and output ports from which it can receive and send client packets. Some of the routers 106 of the NoC 104 are connected to the client interfaces using two of the router ports: one input port and one output port. Some clients may be connected to the router using more than one client interface. A router consists of buffering, a switching fabric, and the routing algorithm that determines the appropriate output port for forwarding packets received from the input ports. The buffering structure within the router can be organized as input, output and centralized storage. The plurality of routers 106 may function similarly to network routers in larger scale computer networks. Further, the plurality of routers 106 may be designed to operate within the constraints and requirements of the NoC 104. In operation, the plurality of routers 106 may receive data packets on their input port and determine an appropriate output port based on the routing algorithm. Thereafter, the data packets may be forwarded to one or more routers of the plurality of routers 106 accordingly. The routing algorithm may determine routing logic such that the optimal path may be determined through which the data packets may be routed from the source router to the destination router within the network. Further, the routing algorithm may employ the plurality of links 108 to connect the plurality of routers 106. Such links may correspond to one or more physical or logical connections between the plurality of routers 106. The plurality of links 108 may carry the data packets across the network. The plurality of links 108 may be implemented using physical interconnects such as wires, or optical links, based on the performance and design requirements of the NoC 104. The plurality of links may follow any data link layer protocol that ensures a coherent point-to-point communication. The plurality of links 108 may further vary in width (for example, a number of parallel data lines) and data rates. For example, the time taken for the data packet to travel from one end of a link to the other end is called link delay, and the amount of data packets that can be transmitted over the link in a given time period is called bandwidth. For example, the width (such as 32 bit or 64 bit) of a link may vary to support different data rates. The time taken for the data packet to travel from the source client to the destination client is called latency. The maximum amount of data all the clients can receive if all of the clients are sending packets all the time is called throughput.

To manage high bandwidth, multiple point-to-point communication protocols can be employed. These may include low-latency protocols such as wormhole transfer, or protocols like scaled pipelining, which reduce wire lengths to achieve higher clock frequencies. Additionally, the plurality of links 108 can be optimized for power efficiency using techniques like clock gating.

Examples of the routing algorithm may include, but are not limited to, a deterministic routing algorithm, an adaptive routing algorithm, and an oblivious routing algorithm. The deterministic routing algorithm may use pre-defined paths for routing the data packets. This may facilitate each of the data packets following a pre-determined path. Further, the deterministic routing algorithm may be simple in implementation. However, this may lead to congestion on a heavily used path. Further, the adaptive routing algorithm may dynamically adjust the path for routing the data packets based on current network conditions, thereby avoiding congestion. In an example, a source-destination pair may follow the same path in the deterministic routing, while the data packets may take alternative paths if the pre-defined path may be congested or blocked in the adaptive routing. Further, the paths may be chosen without regard to current network conditions in the oblivious routing algorithm, thereby balancing simplicity and performance. It is to be noted that the disclosure is not limited to the deterministic routing algorithm, the adaptive routing algorithm, or the oblivious routing algorithm, and may include other routing algorithms well known in the art, for example, source routing, distributed routing, hierarchical routing, and the like.

In an example, the data packets may be generated by a source client (or the source node). Thereafter, the generated data packets may be transmitted from the source node to a destination client (or an end node) via the plurality of routers 106 and the plurality of physical links 108. To transmit the data packets from the source node to the destination node, the data packets may route through one or more intermediate routers (one or more routers from the plurality of routers 106) and the plurality of physical links 108. In such a scenario, the plurality of routers 106 are connected to one another to establish a network. Such plurality of routers 106 may be connected through various network topologies. Examples of the network topologies may include, but are not limited to, a mesh topology, a fat tree topology, a torus topology, a ring topology and any other family of topologies. It is also possible to build new topologies by composition of two or more topologies. The selection of the topology follows several design criteria.

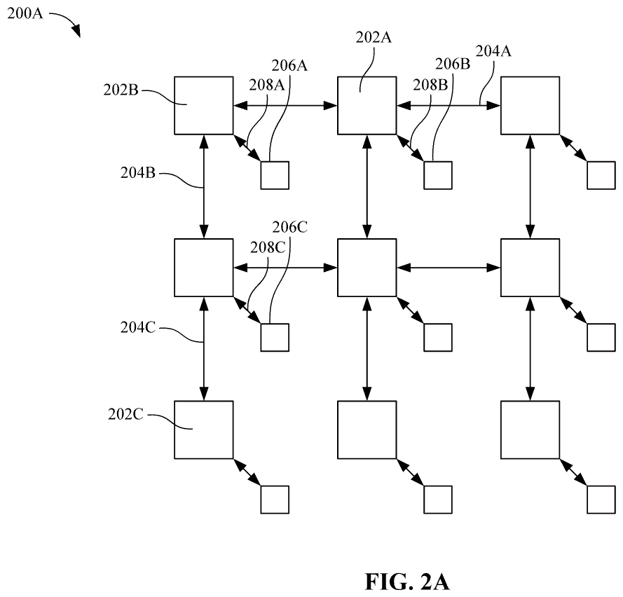

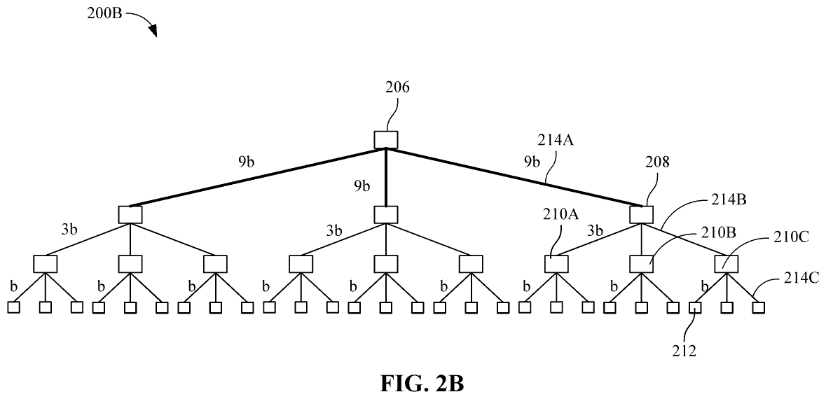

The mesh topology may correspond to a simple and popular topology where the plurality of routers 106 may be arranged in a grid-like pattern. Further, each router of the plurality of routers 106 may be connected to its neighboring routers, thereby providing multiple paths for data transmission. Details of the mesh topology are provided, for example, in FIG. 2. Further, a torus topology may be similar to a mesh topology. However, in the torus topology the edge routers may be linked using wrap-around connections, thereby enhancing connectivity and reducing average communication distance. In a ring topology, the plurality of routers 106 may be connected in a circular fashion. Further, the tree topology may correspond to a hierarchical structure with the plurality of routers 106 organized in a tree-like configuration. This may facilitate a natural hierarchical communication pattern for various applications. In an example, a user (for example, a designer) may create custom topologies tailored to specific application requirements, optimizing for factors like latency, power consumption, and area.

Due to scalability limitations of traditional SoCs, the Network-on-Chip (NoC) 104 has emerged as a system to interconnect a large number of components on the chip. The NoC 104 is an advanced solution that enables efficient communication between various components (or intellectual property (IP) blocks) such as the processor 112, the memory block 114, and the peripheral 118. The NoC is thought of as a service ensuring communication between heterogeneous IP blocks. The NoC is able to accommodate the different needs and requirements of the different IP blocks in terms of interfaces, communication patterns and bandwidth. It is a service that relieves the SoC designers from worrying about how communication is implemented between the different heterogeneous IP blocks.

A two-dimensional (2D) NoC matches the 2D nature of the chip layout. It is perfectly compatible with the chip design paradigm where all the components of the chip are laid out in a 2D plane. In the 2D NoC, the plurality of routers may be interconnected through the plurality of links designed in a horizontal and vertical manner, thereby resembling a grid-like topology. In an example, the plurality of routers may be arranged in a grid-like pattern across a plurality of rows and a plurality of columns, thereby facilitating communication paths between any node in the network. Despite the fact that the 2D mesh NoC is very practical in terms of reachability and simplicity of its routing algorithm, its performance turns out to be very poor. Indeed, the accumulation of congestion due to the potential collision of the multiple clients that can generate packets aiming to go on the same link brings the performance to a plummeting level very fast. Several techniques exist to enhance the performance of the mesh. These techniques range from the multiplication of the links between the routers to the restriction of the routing over certain links to reduce the congestion and the dedication of other links based on the routing distance of the packets. All of these techniques help make the 2D mesh achieve better performances but are complex in implementation and require a long development, verification and modeling effort to fine tune and tailor them to the needs of the design at hand.

To overcome limitations of a 2D mesh, the use of other NoC topologies may be considered. However, many of the other topologies, like the fat-tree or the hypercube, despite their higher performance levels, have structures that are not adapted to the 2D layout of chips today. The modern chip industry is moving towards a massively parallel paradigm where the chip is divided into tiles that are connected together using the NoC. The tile structure being inherently 2D eliminates the NoC topologies that are not compatible or cannot easily be transformed into a 2D structure.

One approach involves creating a topology that combines a 2D mesh with another topology that surpasses the mesh in performance. This combination is conceptually similar but not identical to function composition in calculus. The third dimension is utilized to “instantiate” the composed topology while maintaining the 2D structure of the mesh, resulting in what is referred to as a 3D NoC.

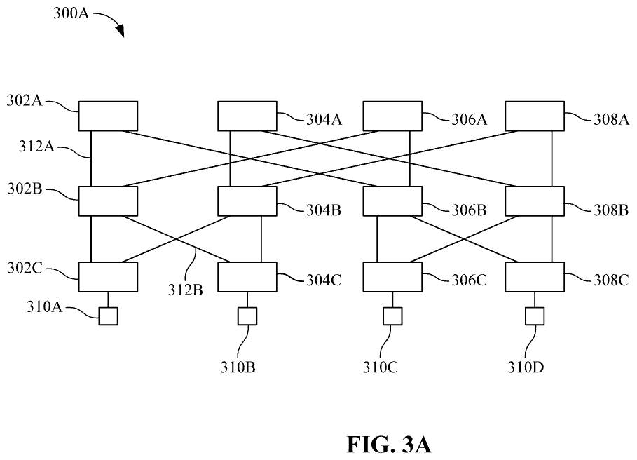

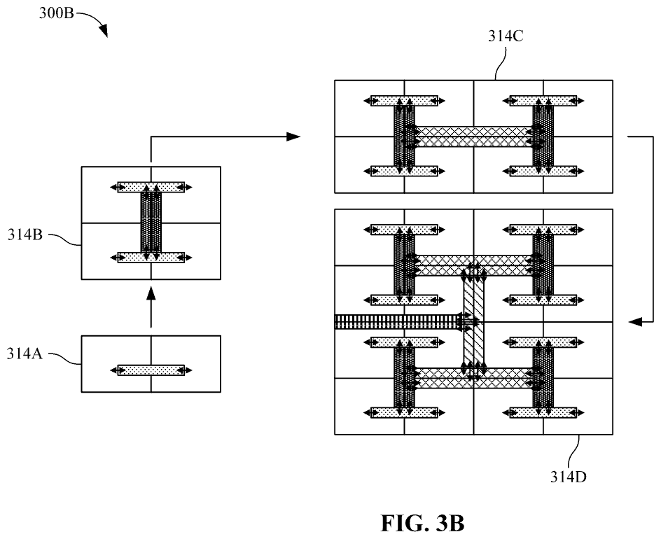

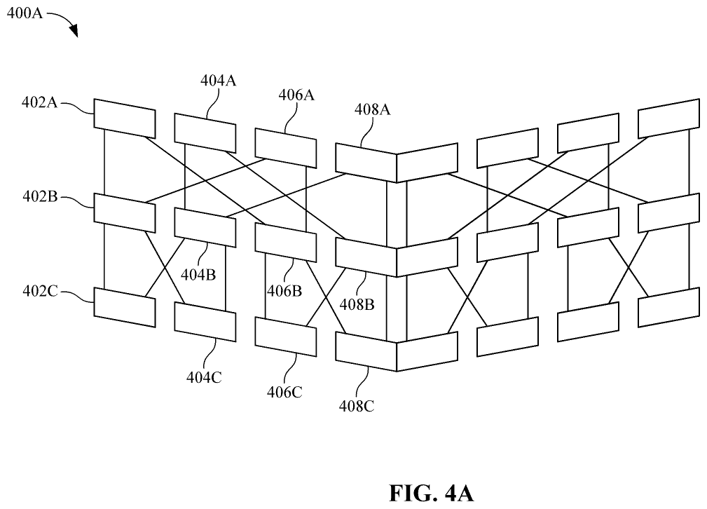

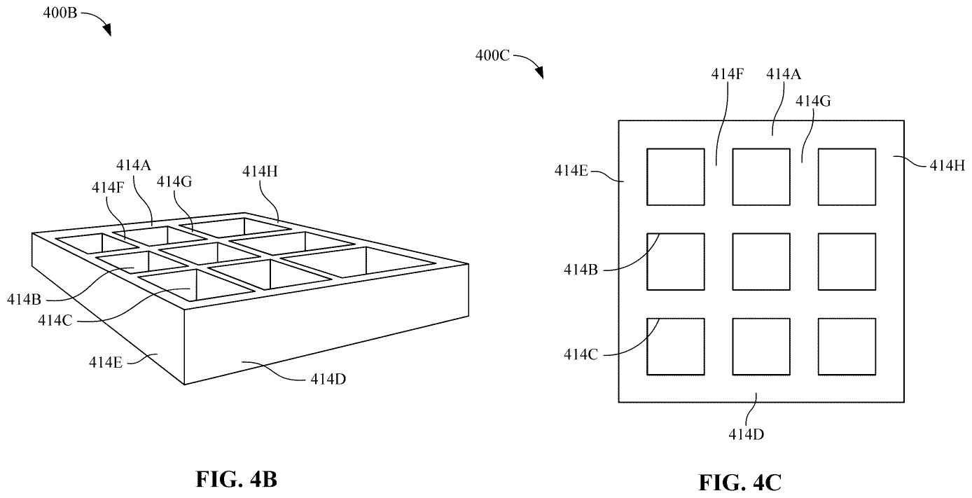

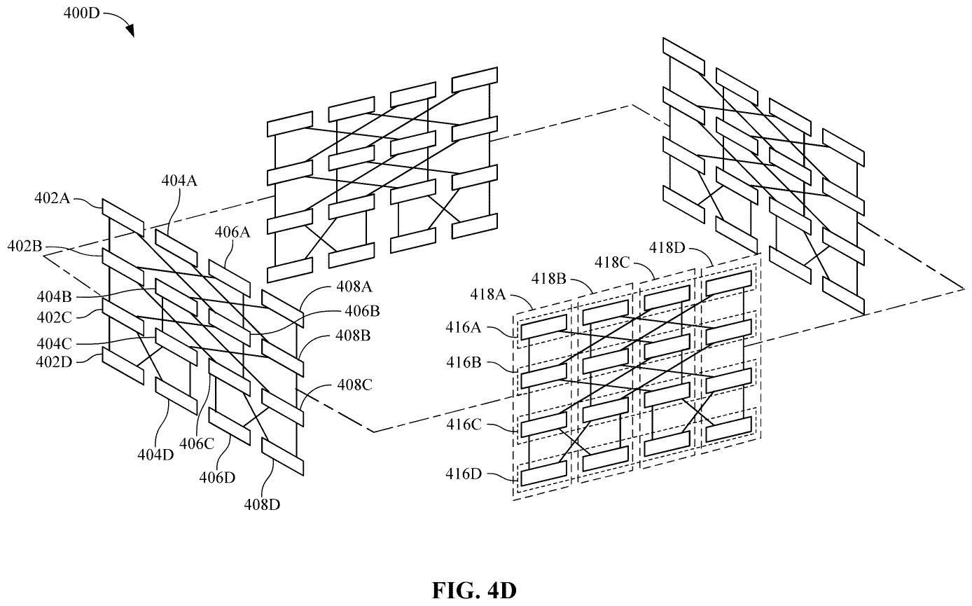

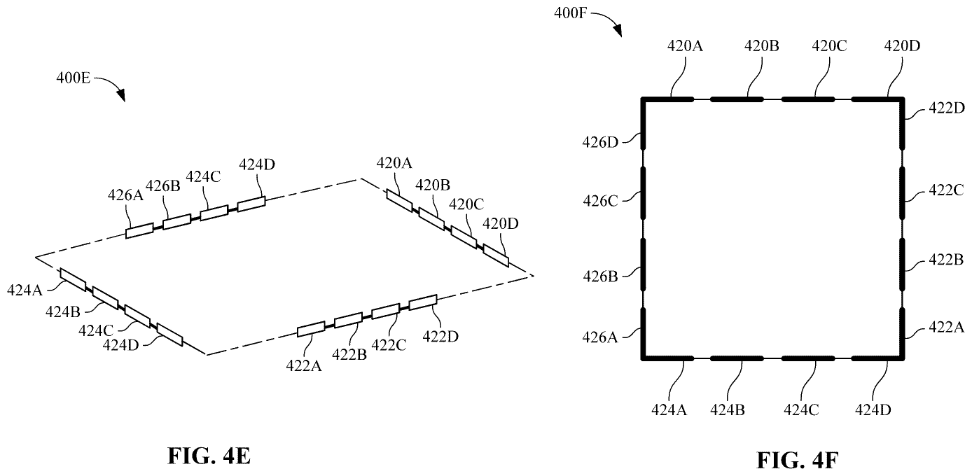

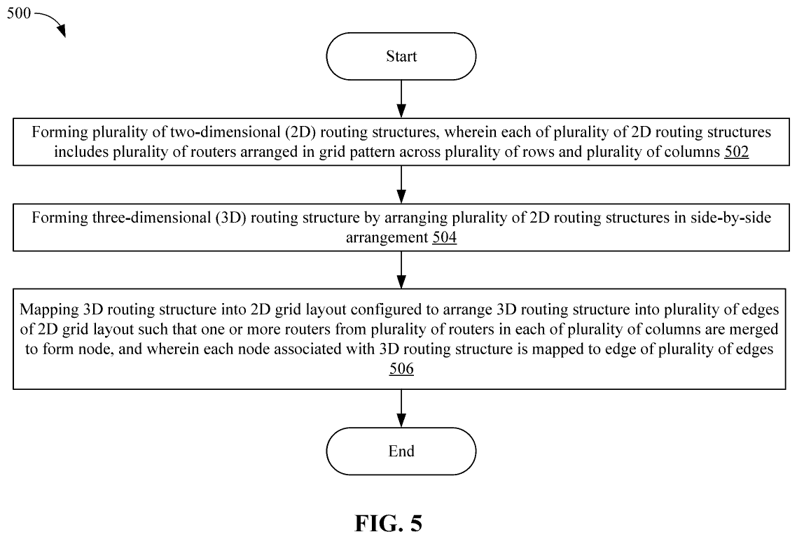

Details associated with the various network topologies, and the designing of the NoC, are further described in detail in conjunction with, for example, FIG. 2A, FIG. 2B, FIG. 3A, FIG. 3B, FIG. 4A, FIG. 4B, FIG. 4C, FIG. 4D, FIG. 4E, FIG. 4F, and FIG. 5.

FIG. 2A illustrates an exemplary two-dimensional mesh topology 200A, in accordance with an embodiment of the present disclosure. FIG. 2A is explained in conjunction with elements of FIG. 1. The 2D mesh topology 200A includes the plurality of routers such as, but not limited to, 202A, 202B, and 202C (collectively referred to as the plurality of routers 202) arranged in a grid-like structure of a plurality of rows and a plurality of columns. Each router of the plurality of routers 202 may be connected to an adjacent router via a link from the plurality of links such as, but not limited to 204A, 204B, and 204C (collectively referred to as the plurality of links 204). Each router of the plurality of routers 202 may be connected to one local client from the plurality of clients such as, but not limited to, 206A, 206B and 206C (collectively referred to as the plurality of clients 206). The plurality of clients 206 are connected to their respective router through their local links such as, but not limited to, 208A, 208B and 208C (collectively referred to as the plurality of local links 208). It may be understood that the plurality of routers 202, and the plurality of links 204 are examples of the plurality of routers 106 and the plurality of links 108 of FIG. 1, respectively.

The 2D mesh topology 200A may be the most adopted topology in the NoCs for chips designed today. It is based on a 2D grid structure that uses the plurality of routers 202 connecting locally to a client 206 through a client interface connected to links 208. The plurality of routers 202 are connected together where each router of the plurality of routers 202 may be arranged in the plurality of rows (in an X-direction), and the plurality of columns (in a Y-direction), thereby forming the 2D grid layout. The most basic routing algorithm is the XY routing algorithm that uses deterministic paths to route data sent from one client to the other. The XY algorithm routes the data in the X direction first until it reaches the destination client's column and then routes it in the Y direction until it reaches the destination client's local router. Such routing algorithm may be straightforward, thereby implemented efficiently, and can ensure predictable and reliable transfer of the data packets. This can provide predictable routing paths, thereby making it suitable for compact and efficient communication architecture. Further, the 2D mesh topology 200A may be deployed in the system to facilitate communication between the different units that constitute the clients of the NoC.

In an example, each of the plurality of links 108 (in FIG. 1) connects at least two of the plurality of routers 106 based on the mesh topology across at least one of: the plurality of rows, or the plurality of columns for the NoC 104. Further, the 2D mesh topology 200A of FIG. 2A may use the plurality of routers 202 with a single link 204, thereby reducing the throughput such as to 25% of wire speed, or 30% of the wire speed in selected rare cases. (Of course, these are just examples, and the present disclosure is not limited thereto.) Such a performance may be due to the inherent structure of the mesh that may be prone to congestion and accumulated contention. In order to alleviate this issue, current chip designers are resorting to the use of enhancing techniques such as, but not limited to, multiplication of ports in the plurality of routers 202. Further, multiple local connections may be employed for each router, thereby decreasing a number of the plurality of routers 202 and decreasing an average number of hops. A “hop” corresponds to a transfer of the data packet from one router to another. In an example, one or more virtual channels may be employed, thereby allowing the multiplexing of ports to reduce the effects of congestion by dynamically sharing the port bandwidth. This can facilitate mitigation of congestion and improve the performance of the 2D mesh topology 200A.

FIG. 2B illustrates an exemplary fat tree topology 200B, in accordance with an embodiment of the present disclosure. FIG. 2B is explained in conjunction with elements of FIG. 1 and FIG. 2A. The fat tree topology 200B includes the plurality of routers arranged in a tree-like structure. This may facilitate a hierarchical communication pattern for the plurality of routers arranged in a tree form. In this structure, the plurality of routers may be arranged in the hierarchical arrangement including a root node, intermediate nodes, and leaf nodes, with each node connected to one or more child nodes, except the root node. For example, the one or more child nodes are client nodes providing networking infrastructure in client environments. For example, the plurality of routers may include, but are not limited to, a first router 206, a second router 208, a third router 210A, a fourth router 210B, and a fifth router 210C. It may be understood that the plurality of routers (the first router 206, the second router 208, the third router 210A, the fourth router 210B, and the fifth router are examples of the plurality of routers 106 of FIG. 1. Although in FIG. 2B it is shown that the fat tree topology 200B is a 3-way fat-tree topology, the disclosure may not be so limiting, and the fat tree topology 200B may include fewer or more components to perform the same or other functions.

In an example, the fat tree-topology may correspond to a k-ary n-tree, where k represents a number of child nodes that each node has, and n represents a number of levels in the tree. In an embodiment, the fat tree topology 200B may provide a scalable, fault tolerant, and high-bandwidth infrastructure. Further, the fat tree topology 200B may be designed to efficiently handle large volumes of data traffic within the network. As shown, the fat tree topology 200B may be hierarchical and comprise multiple layers of routers, for example, but not limited to a core layer, an aggregation layer, and an access layer.

The core layer may correspond to a highest layer including a core router (or root node or the first router 206) that connects to the one or more routers in the aggregation layer. The aggregation layer may correspond to a middle layer that connects the core layer to the access layer. In an embodiment, the tree starts being built from the leaves (client node 212) until it reaches the core layer. At every router, a link bandwidth of each link connected to upper order routers is multiplied by the number of links connected to the lower orders making the link bandwidth at every stage a multiple of the link bandwidth at the lower stage, hence the topology name. For example, the fifth router 210C connects with three client nodes 212 (or end nodes) in downward links 214C, and the link bandwidth for each client node 212 may be depicted as “b”. Further, the link bandwidth of the fifth router 210C (for the link 214B between the second router 208 and the fifth router 210C) may be multiplied by 3, and therefore the link bandwidth may be determined as “3b”. Similarly, the link bandwidth for the second router 208 (for the link 214A between the first router 206 and the second router 208) may be determined as “9b”. In an example, the higher layers may have more bandwidth to handle aggregated traffic from lower layers, thereby avoiding bottlenecks. It may be understood that the plurality of links (the link 214A, the link 214B, and the link 214C, are examples of the plurality of links 108 of FIG. 1

In an example, each of the plurality of links 108 (see FIG. 1) connects at least two of the plurality of routers 106 based on the 3-way fat tree topology across at least one of: the plurality of rows, or the plurality of columns for the NoC 104. Further, the fat tree topology 200B and structure can provide a clear advantage compared to other networks as it is inherently capable of absorbing all the bandwidth coming from lower layers.

FIG. 3A illustrates an exemplary multistage fat tree topology 300A, in accordance with an embodiment of the present disclosure. FIG. 3A is explained in conjunction with elements of FIG. 1, FIG. 2A, and FIG. 2B. The multistage fat tree topology 300A may include the plurality of routers 106 connected with the plurality of links 108. Although in FIG. 3A it is shown that the multistage fat tree topology 300A is a binary tree based multistage fat tree topology, the disclosure may not be so limiting, and the multistage fat tree topology 300A may include fewer or more components to perform the same or other functions.

With reference to FIG. 3A, the 2D routing structure includes the plurality of routers arranged in a grid pattern across a plurality of rows and a plurality of columns. The plurality of routers may include, for example routers 302A, 304A, 306A, and 308A across a first row of the plurality of rows. Further, the plurality of routers may include, for example, routers 302B, 304B, 306B, and 308B across a second row of the plurality of rows, and routers 302C, 304C, 306C, and 308C across a third row of the plurality of rows. Similarly, the plurality of routers may include routers 302A, 302B, and 302C across a first column of the plurality of columns. Further, the plurality of routers may include routers 304A, 304B, and 304C across a second column of the plurality of columns, and the plurality of routers may include routers 306A, 306B, and 306C across a third column of the plurality of columns. The plurality of routers may include routers 308A, 308B, and 308C across a fourth column of the plurality of columns.

In an embodiment, the 2D routing structure further includes a plurality of end nodes, for example, but not limited to 310A, 310B, 310C and 310D. Each of the plurality of columns terminates at a corresponding end node from the plurality of end nodes. For example, the first column terminates at the end node 310A, the second column terminates at the end node 310B, the third column terminates at the end node 310C, and the fourth column terminates at the end node 310D. In an embodiment, the 2D structure further includes a first edge and an opposing second edge. For example, the first column may correspond to the first edge, and the fourth column may correspond to the second edge.

The 2D routing structure further includes the plurality of links for example 312A and 312B. Further, each of the plurality of links connects at least two of the plurality of routers. As shown, a link 312A connects the routers 302A and 302B across the column, and the link 312B connects the routers 302B and 304C across the rows. In an embodiment, the plurality of routers may be connected with the plurality of links based on predefined topology across at least one of the plurality of rows, or the plurality of columns. In an example, the predefined topology may be associated with a multistage fat tree topology.

The multistage fat tree topology may correspond to a hierarchical network architecture. The multistage fat tree topology can provide scalable, high-bandwidth, and fault tolerant interconnections. This may be employed in a high-performance computing environment. Further, the multistage fat tree topology can enhance traditional tree structures by increasing bandwidth and redundancy while moving higher up in the hierarchy, thereby ensuring efficient data flow and load balancing. In an example, the multistage fat tree topology may be structured in multiple layers, each layer representing a different level of hierarchy. The lowest layer may include the plurality of end nodes; this may also be referred to as an access layer or leaf layer. The plurality of end nodes may connect directly to end devices and to a plurality of routers of the aggregation layer. The aggregation layer may include the second row and the third row. The plurality of routers of the aggregation layer may collect the data packets from the access layer and forward them to the plurality of routers of the core layer. The core layer may correspond to the topmost layer in the hierarchy.

It is to be noted that the exemplary multistage fat tree topology 300A is actually the same arrangement of the exemplary fat tree topology 200B with the difference that instead of multiplying the bandwidth of the links going upwards we duplicate the routers. At every stage, the total bandwidth remains the same. This may enable scalability of the fat tree topology as doubling the link bandwidth has limits and is not implementation friendly.

FIG. 3B illustrates an exemplary layout 300B for the fat tree topology 300A, in accordance with an embodiment of the present disclosure. FIG. 3B is explained in conjunction with elements of FIG. 1, FIG. 2A, FIG. 2B and FIG. 3A. The layout 300B may represent a 2D representation of the fat tree topology 300A. The layout 300B may include a first group 314A, a second group 314B, a third group 314C, and a fourth group 314D. Each group includes the plurality of routers 106 connected with the plurality of links 108.

In operation, the 2D representation of the fat tree topology 200B may include connecting the plurality of routers 106 using the plurality of links 108 to form a group at multi-stages, for example, but not limited to, level 0, level 1, level 2, and level 3. For example, at level 0, two routers of the plurality of routers 106 may be connected with a link therebetween to form a cluster. The link connecting the two routers may be represented as a connection filled with a dotted pattern. Further, the cluster may be referred to as the first group 314A, hereinafter. Thereafter, at level 1, two similar clusters of the first group 314A may be connected with the plurality of links. Further, each cluster of the first group 314A may be similar thereby implying that each cluster of the first group 314A may have the same physical and functional properties.

The link connecting the two clusters of the first group 314A may be represented as a connection filled with a brick pattern. Further, the cluster may be referred to as the second group 314B, hereinafter. At level 2, two similar clusters of the second group 314B may be connected with the plurality of links. The link connecting the two clusters may be represented as a connection filled with a diamond pattern. Further, the cluster may be referred to as the third group 314C, hereinafter. At level 3, two similar clusters of the third group 314C may be connected with the plurality of links. The link connecting the two clusters may be represented as a connection filled with a diagonal pattern. Further, the cluster may be referred to as the fourth group 314D, hereinafter.

Such 2D representation of the fat tree topology 200B requires a highly significant amount of effort and extra care in terms of place and route exercise and may result in a process that can take a large number of iterations before reaching an acceptable outcome in terms of the final chip layout. This results in an added complexity for the whole back-end effort.

FIG. 4A illustrates an exemplary 3D routing structure 400A of the multistage fat tree topology 300A, in accordance with an embodiment of the present disclosure. FIG. 4A is explained in conjunction with elements of FIG. 1, FIG. 2A, FIG. 2B, FIG. 3A, and FIG. 3B. The 3D routing structure 400A may include a plurality of 2D routing structures arranged in a side-by-side arrangement. Although in FIG. 4A it is shown that the 3D routing structure 400A includes the binary tree-based multistage fat tree topology as a foundation of the 3D NoC, the disclosure may not be so limiting, and the 3D routing structure 400A may include other multistage fat tree topologies that may include fewer or more components to perform the same or other functions.

In an embodiment, each of the plurality of 2D routing structures may be identical. This may imply that each of the plurality of 2D routing structures may have the same physical and functional properties. For example, each of the plurality of 2D routing structures may have the same number of the plurality of routers 106, and the same number of the plurality of links 108. Further, the plurality of routers 106 may be connected with the plurality of links 108 using the same network topology in each of the plurality of 2D routing structures. Further, a first edge of each of the plurality of 2D routing structures may be arranged adjacent to a second edge of an adjacent 2D routing structure from the plurality of 2D routing structures to form the 3D routing structure. For example, if a first 2D structure of the plurality of 2D routing structures corresponds to the binary tree-based multistage fat tree topology, then each of the plurality of 2D routing structures may correspond to the binary tree-based multistage fat tree topology. Thereafter, to design the 3D routing structure, the first edge of the first 2D routing structures may be arranged adjacent to the second edge of the adjacent 2D routing structure to form a wall-like structure. In an example, the two adjacent 2D structures may be locally interconnected using the plurality of links to form the side-by-side arrangement.

FIG. 4B illustrates a perspective view 400B of the exemplary 3D routing structure 400A of the multistage fat tree topology 300A, in accordance with an embodiment of the present disclosure. FIG. 4B is explained in conjunction with elements of FIG. 1, FIG. 2A, FIG. 2B, FIG. 3A, FIG. 3B, and FIG. 4A. With reference to FIG. 4B, there is shown a basic structure of the 3D routing structure 400A of the multistage fat tree topology 300A. For example, the plurality of 2D routing structures may correspond to eight structures. Among the eight structures, four 2D structures may be arranged between a first direction, say east direction, and a second direction, say west direction. The second direction is parallel to the first direction. These four 2D structures are depicted as 414A, 414B, 414C and 414D. Further, the other four 2D structures of the eight structures may be arranged between a third direction, say north direction, and a fourth direction, say south direction. The third direction and the fourth direction may be perpendicular to the first direction and the second direction. These other four 2D structures are depicted as 414E, 414F, 414G and 414H. The first direction, the second direction, the third direction, and the fourth direction correspond to arbitrary four directions on a plane. In an example, each of the four 2D routing structures may be arranged in a grid-like arrangement to form a plurality of interleaved wall-like structures.

Referring to FIG. 4B, eight structures are arranged in a grid-structure, so that the four 2D routing structures 414A, 414B, 414C and 414D arranged between the first direction and the second direction are arranged to be parallel to each other. Further, each of the other four 2D structures 414E, 414F, 414G and 414H arranged between the third direction and the fourth direction is perpendicular to all the four 2D routing structures 414A, 414B, 414C and 414D. Each of the 2D structures 414A, 414B, 414C and 414D hence intersects all the other 2D structures 414E, 414F, 414G and 414H that are arranged in different directions. Every pair of 2D structures that intersect each other may have a single intersection point. The intersection point corresponds to a pair of router columns from the pair of 2D structures intersecting each other. The index of the router column corresponds to the index of the row/column of the pair of 2D structures intersecting each other.

For example, let's label the columns of each 2D structure taken from FIG. 3A as 0, 1, 2 and 3 for columns terminated respectively by client 310A, 310B, 310C and 310D. Let's also label each 2D structure disposed horizontally with a row index R0, R1, R2 and R3. Similarly, let's label each 2D structure disposed vertically with column index C0, C1, C2 and C3. In FIG. 4B we can therefore state that the horizontal 2D structures 414A, 414B, 414C and 414D correspond to row indexes R0, R1, R2 and R3, respectively. In FIG. 4B we can also state that vertical 2D structures 414E, 414F, 414G and 414H correspond to column indexes C0, C1, C2 and C3, respectively. From the labeling above we can clearly observe that 2D structure 414A intersects 2D structure 414E. The intersection point is made of column 0 of 414A and column 0 of 414E. Similarly, the intersection point of 2D structures 414B and 414F is made of column 2 of 414B and column 1 of 414F.

FIG. 4C illustrates a top view 400C of the exemplary 3D routing structure 400B of the multistage fat tree topology 300A, in accordance with an embodiment of the present disclosure. FIG. 4C is explained in conjunction with elements of FIG. 1, FIG. 2A, FIG. 2B, FIG. 3A, FIG. 3B, FIG. 4A, and FIG. 4B. With reference to FIG. 4C, all edges represented in FIG. 4B are shown. FIG. 4C is a top view diagram of FIG. 4B.

FIG. 4D illustrates an exploded view 400D of the exemplary 3D routing structure 400B of the multistage fat tree topology 300A, in accordance with an embodiment of the present disclosure. FIG. 4D is explained in conjunction with elements of FIG. 1, FIG. 2A, FIG. 2B, FIG. 3A, FIG. 3B, FIG. 4A, FIG. 4B, and FIG. 4C. With reference to FIG. 4D, there is shown each of the four 2D routing structures arranged in the side-by-side arrangement to form the 3D routing structure. Further, each of the four 2D routing structures may include 4 rows, indicated as a row 416A, a row 416B, a row 416C and a row 416D. Moreover, each of the four 2D routing structures may include 4 columns, indicated as a column 418A, a column 418B, a column 418C and a column 418D.

FIG. 4E illustrates an exploded view 400E of the exemplary 3D routing in a 2D grid layout, in accordance with an embodiment of the present disclosure. FIG. 4E is explained in conjunction with elements of FIG. 1, FIG. 2A, FIG. 2B, FIG. 3A, FIG. 3B, FIG. 4A, FIG. 4B, FIG. 4C, and FIG. 4D. With reference to FIG. 4E, there is shown the 2D grid layout having a plurality of edges such that one or more routers from the plurality of routers in each of the plurality of columns are merged to form a node.

Traditionally, a design and implementation of the 3D routing structure may be complex. Since the plurality of 2D routing structures may be stacked onto each other to form the 3D routing structure. In this case, the one or more links of the plurality of links connecting the one or more routers from the plurality of routers in each of the plurality of columns need careful planning to minimize interference. To overcome the limitation associated with the design complexity of the 3D routing structure, the proposed NoC 104 may be designed such that the 3D structure may be mapped into a 2D grid layout, thereby implementing the third dimension of the 3D routing structure virtually. This can allow the plurality of electronic design automation (EDA) tools used for implementing the plurality of 2D routing structure to map the 3D routing structure as the 2D grid layout to form the network on chip topology.

Referring to FIG. 4E, one or more routers from the plurality of routers in each of the plurality of columns are merged to form a node. For example, the one or more routers 402A, 402B, 402C and 402D of the first column 418A may be merged to form a first node 420A. Similarly, one or more routers 404A, 404B, 404C and 404D of the second column 418B may be merged to form a second node 420B. Similarly, the one or more routers 406A, 406B, 406C and 406D of the third column 418C may be merged to form a third node 420C. Moreover, the one or more routers 408A, 408B, 408C and 408D of the fourth column 418D may be merged to form a fourth node 420D. Each node of the plurality of nodes 420A, 420B, 420C and 420D may be mapped to, for example, the first edge 414A of the plurality of edges. Similarly, one or more nodes of the plurality of nodes, for example, but not limited to 422A, 422B, 422C and 422D may be mapped to the second edge 414B of the 3D routing structure, and the one or more nodes, for example, but not limited to 424A, 424B, 424C and 424D may be mapped to the third edge 414C of the 3D routing structure. Further, the one or more nodes, for example, but not limited to 426A, 426B, 426C and 426D may be mapped to the fourth edge 414D of the 3D routing structure.

In an embodiment, one or more links of the plurality of links connecting the one or more routers from the plurality of routers in each of the plurality of columns may be locally interconnected. Further, such connections between the one or more routers may include no wired connections, thereby implementing direct connections between the one or more routers. Further, the plurality of links connecting the plurality of nodes may correspond to physical links on NoC 104. Similarly, for each of the plurality of 2D structures, one or more routers from the plurality of routers in each of the plurality of columns are merged to form the node.

For example, such an implementation of the 3D routing structure employs a 2D representation where the one or more routers from the plurality of routers in each of the plurality of columns may be merged into a single node and a plurality of links connecting the one or more routers from the plurality of routers in each of the plurality of columns may be implemented locally. Further, each of the plurality of links connected to each node of the plurality of nodes in forming the edge of the 2D grid layout may be arranged horizontally in the 2D plane. This may provide multiple paths for the data packets to reach different destinations, thereby reducing a number of hops needed for the data packets to be routed to reach different destinations as compared to mesh topology.

It is notable that, when the 3D routing structure may be formed by arranging the plurality of 2D routing structures in the side-by-side arrangement, the one or more routers from the plurality of routers in each of the plurality of columns may correspond to a Z-axis of a 3D plane, and the one or more routers from the plurality of routers in each of the plurality of rows may correspond to a X-axis, and a Y-axis of the 3D plane. However, in the proposed 3D NoC 104, the more routers from the plurality of routers in each of the plurality of columns may be merged, thereby eliminating the third dimension (Z-axis). This provides a 2D grid layout with operational capabilities, and performance of the 3D routing structure, and a less complicated design layout than the 3D routing structure. Further, such 2D grid layout having a plurality of edges configured to incorporate the 3D routing structure makes the design layout compatible with the 2D routing structure requirement of the back-end layout producing process (for example, electronic design automation (EDA) tools). Further, one or more links connecting the plurality of nodes may be duplicated without any change in the routing algorithm. This may allow ease of scalability of the 3D routing structure to increase performance.

The plurality of EDA tools may correspond to software applications configured to design, simulate, verify, and layout integrated circuits. The plurality of EDA tools may help engineers automate complex design processes, thereby ensuring accuracy, efficiency, and reducing the time to market the semiconductor devices. Such plurality of EDA tools may provide a comprehensive suite of functionalities, for example, not limited to capturing circuit schematics, simulation of layout design, and physical verification. Further, the EDA tools may facilitate automating the process of mapping of the routing structure onto an integrated circuit. Examples of the plurality of EDA tools may include, but are not limited to, Altium designer, Synopsys design compiler, Cadence design systems, and the like.

In operation, while designing the NoC 104, architecture specification plays an important role. This may include details about a type of multistage fat tree topology, such as but not limited to a number of stages, a number of routers, a number of links per router, and a number of end nodes, in addition to performance metrics, such as power consumption, speed, and area constraints. Upon the completion of design specification, a schematic model may be created that defines the logical structure of the circuit. Specifically, the structural model describes the plurality of routers and their interconnections. The embodiments of the present disclosure may also encompass a design planning tool that allows architecture exploration for designing the NoC 104. The aim of the tool is to help designers obtain estimates of a projected size, a performance and a power consumption of the NoC given certain input parameters. Based on the desired settings, the design planning tool is able to produce a netlist that contains a structure of the NoC 104 with all of the internal details of each component (routers, links and client interfaces).

FIG. 4F illustrates a top view 400F of the exemplary 3D routing structure in the 2D grid layout, in accordance with an embodiment of the present disclosure. FIG. 4F is explained in conjunction with elements of FIG. 1, FIG. 2A, FIG. 2B, FIG. 3A, FIG. 3B, FIG. 4A, FIG. 4B, FIG. 4C, FIG. 4D, and FIG. 4E. With reference to FIG. 4F, there is shown the 2D grid design of the 3D routing structure for deployment of the NoC 104. The 2D grid design may include 4 edges, where each edge comprises a plurality of nodes. For example, a particular edge, say 414A may include the nodes 420A, 420B, 420C and 420D. Moreover, each node of the 420A, 420B, 420C and 420D may include a plurality of routers, say 4 routers arranged in a column and connected to other routers of other nodes and/or edges.

In an embodiment, the deployment of the NoC 104 includes implementation and integration of architecture of the NoC 104 into an integrated circuit. Upon formation of the detailed physical design, an integration of the NoC 104 may be coordinated with the IP blocks. Further, the network interface 120 may be implemented to facilitate exchange of data packets. Further, a semiconductor manufacturing process may be employed to physically implement the integrated chip including the NoC 104. Thereafter, the implemented integrated chip may be integrated into a hardware platform or system board, and to leverage the capabilities of the NoC 104, software development tools may be developed or adapted to interface with the NoC 104. Examples of the software development tools may include, but are not limited to embedded integrated development environments, and compiler toolchains. Thereafter, the integrated hardware-software system may be installed into the product or application environment.

In an embodiment, a design and implementation of the proposed 3D NoC is compatible with a plurality of electronic design automation (EDA) tools used for implementing the plurality of 2D routing structure. Further, such a design of the 3D NoC, when deployed on the integrated chip, facilitates the integrated chip to be compatible with existing hardware platforms or system boards. Since the proposed NoC 104 may be designed such that the 3D structure may be mapped into the 2D grid layout, thereby facilitating the hardware platform or system board to interconnect with the proposed 3D NoC 104 in a manner similar to the traditional 2D NoCs. Therefore, the proposed NoC 104 compatible with the existing devices may leverage the use of the 2D grid layout to ensure reliability, performance, and efficiency similar to the 3D NoC.

FIG. 5 illustrates a flowchart 500 of an exemplary computer implemented method for implementing a network on chip, in accordance with an embodiment of the present disclosure. FIG. 5 is explained in conjunction with elements of FIG. 1, FIG. 2A, FIG. 2B, FIG. 3, FIG. 4A-4G, and FIG. 5. The operations of the exemplary computer implemented method may be executed by any computing system, for example, by the system 102 of FIG. 1. The operations of the flowchart 500 may start at 502.

At 502, the plurality of two-dimensional (2D) routing structures is formed. In an embodiment, each of the plurality of 2D routing structures includes a plurality of routers arranged in a grid pattern across a plurality of rows and a plurality of columns. Further, each of the plurality of 2D routing structures includes a plurality of links. Each of the plurality of links connects at least two of the plurality of routers based on predefined topology across at least one of: the plurality of rows, or the plurality of columns.

At 504, the three-dimensional (3D) routing structure is formed. In an embodiment, the 3D routing structure may be formed by arranging the plurality of 2D routing structures in a side-by-side arrangement. In an embodiment, each of the plurality of 2D routing structures further includes a first edge and an opposing second edge. The first edge of each of the plurality of 2D routing structures is arranged adjacent to the second edge of an adjacent 2D routing structure from the plurality of 2D routing structures to form the 3D routing structure.

At 506, the 3D routing structure may be mapped into the 2D grid layout. In an embodiment, the 3D routing structure may be mapped into the 2D grid layout configured to arrange the 3D routing structure into a plurality of edges of the 2D grid layout such that one or more routers from the plurality of routers in each of the plurality of columns are merged to form a node. Each node associated with the 3D routing structure is mapped to an edge of the plurality of edges. Further, the 3D routing structure is mapped into the 2D grid layout to form a network-on-chip topology such that the network-on-chip topology is compatible with a plurality of electronic design automation (EDA) tools used for implementing the plurality of 2D routing structure.

Accordingly, blocks of the flowchart 500 support combinations of means for performing the specified functions and combinations of operations for performing the specified functions. It will also be understood that one or more blocks of the flowchart 500 can be implemented by special purpose hardware-based computer systems which perform the specified functions, or combinations of special purpose hardware and computer instructions.

Many modifications and other embodiments of the disclosed technology set forth herein will come to mind to one skilled in the art to which the disclosed technology pertains having the benefit of the teachings presented in the foregoing descriptions and the associated drawings. Therefore, it is to be understood that the disclosed technology is not to be limited to the specific embodiments disclosed and that modifications and other embodiments are intended to be included within the scope of the appended claims. Moreover, although the foregoing descriptions and the associated drawings describe example embodiments in the context of certain example combinations of features and/or functions, it should be appreciated that different combinations of features and/or functions may be provided by alternative embodiments without departing from the scope of the appended claims. In this regard, for example, different combinations of features and/or functions than those explicitly described above are also contemplated as may be set forth in some of the appended claims. Although specific terms are employed herein, they are used in a generic and descriptive sense only and not for purposes of limitation.

What is claimed is

1. A network on chip (NoC), comprising:
a three-dimensional (3D) routing structure comprising a plurality of two-dimensional (2D) routing structures arranged in a side-by-side arrangement, wherein each of the plurality of 2D routing structures comprises a plurality of routers arranged in a grid pattern across a plurality of rows and a plurality of columns; and
a 2D grid layout having a plurality of edges configured to incorporate the 3D routing structure into the plurality of edges such that one or more routers from the plurality of routers in each of the plurality of columns are merged to form a node, and wherein each node is mapped to an edge of the plurality of edges.

2. The NoC of claim 1, wherein each of the plurality of 2D routing structures further comprises a plurality of links, and wherein each of the plurality of links connects at least two of the plurality of routers based on pre-defined topology across at least one of: the plurality of rows, or the plurality of columns.

3. The NoC of claim 2, wherein the pre-defined topology is associated with a multistage fat tree topology.

4. The NoC of claim 1, wherein each of the plurality of 2D routing structures are identical.

5. The NoC of claim 1, wherein each of the plurality of 2D routing structures further comprises a first edge and an opposing second edge, and wherein the first edge of each of the plurality of 2D routing structures is arranged adjacent to the second edge of an adjacent 2D routing structure from the plurality of 2D routing structures to form the 3D routing structure.

6. The NoC of claim 1, wherein the 3D routing structure comprises a plurality of nodes mapped to the plurality of edges of the 2D grid layout, and wherein each edge of the plurality of edges connects two adjacent nodes of the plurality of nodes.

7. The NoC of claim 1, wherein the 3D routing structure is mapped into the 2D grid layout to form a network-on-chip topology such that the network-on-chip topology is compatible with a plurality of electronic design automation (EDA) tools used for implementing the plurality of 2D routing structure.

8. The NoC of claim 1, wherein each of the plurality of 2D routing structures further comprises a plurality of end nodes, and wherein each of the plurality of columns terminates at a corresponding end node from the plurality of end nodes.

9. A system, comprising:
a network on chip (NoC), comprising:
a three-dimensional (3D) routing structure comprising a plurality of two-dimensional (2D) routing structures arranged in a side-by-side arrangement, wherein each of the plurality of 2D routing structures comprises a plurality of routers arranged in a grid pattern across a plurality of rows and a plurality of columns; and
a 2D grid layout having a plurality of edges configured to incorporate the 3D routing structure into the plurality of edges such that one or more routers from the plurality of routers in each of the plurality of columns are merged to form a node, and wherein each node is mapped to an edge of the plurality of edges.

10. The system of claim 9, wherein each of the plurality of 2D routing structures further comprises a plurality of links, and wherein each of the plurality of links connects at least two of the plurality of routers based on pre-defined topology across at least one of: the plurality of rows, or the plurality of columns.

11. The system of claim 10, wherein the pre-defined topology is associated with a multistage fat tree topology.

12. The system of claim 9, wherein each of the plurality of 2D routing structures are identical.

13. The system of claim 9, wherein each of the plurality of 2D routing structures further comprises a first edge and an opposing second edge, and wherein the first edge of each of the plurality of 2D routing structures is arranged adjacent to the second edge of an adjacent 2D routing structure from the plurality of 2D routing structures to form the 3D routing structure.

14. The system of claim 9, wherein the 3D routing structure comprises a plurality of nodes mapped to the plurality of edges of the 2D grid layout, and wherein each edge of the plurality of edges connects two adjacent nodes of the plurality of nodes.

15. The system of claim 9, wherein the 3D routing structure is mapped into the 2D grid layout to form a network-on-chip topology such that the network-on-chip topology is compatible with a plurality of electronic design automation (EDA) tools used for implementing the plurality of 2D routing structure.

16. The system of claim 9, wherein each of the plurality of 2D routing structures further comprises a plurality of end nodes, and wherein each of the plurality of columns terminates at a corresponding end node from the plurality of end nodes.

17. A computer implemented method for implementing a network on chip, comprising a memory to store computer-executable instructions; and one or more processors coupled to the memory, wherein the one or more processors are configured to
forming a plurality of two-dimensional (2D) routing structures, wherein each of the plurality of 2D routing structures comprises a plurality of routers arranged in a grid pattern across a plurality of rows and a plurality of columns;
forming a three-dimensional (3D) routing structure by arranging the plurality of 2D routing structures in a side-by-side arrangement; and
mapping the 3D routing structure into a 2D grid layout configured to arrange the 3D routing structure into a plurality of edges of the 2D grid layout such that one or more routers from the plurality of routers in each of the plurality of columns are merged to form a node, and wherein each node associated with the 3D routing structure is mapped to an edge of the plurality of edges.

18. The computer implemented method of claim 17, wherein each of the plurality of 2D routing structures further comprises a plurality of links, and wherein each of the plurality of links connects at least two of the plurality of routers based on pre-defined topology across at least one of: the plurality of rows, or the plurality of columns.

19. The computer implemented method of claim 17, wherein each of the plurality of 2D routing structures further comprises a first edge and an opposing second edge, and wherein the first edge of each of the plurality of 2D routing structures is arranged adjacent to the second edge of an adjacent 2D routing structure from the plurality of 2D routing structures to form the 3D routing structure.

20. The computer implemented method of claim 17, wherein the 3D routing structure is mapped into the 2D grid layout to form a network-on-chip topology such that the network-on-chip topology is compatible with a plurality of electronic design automation (EDA) tools used for implementing the plurality of 2D routing structure.
